(19) United States
(12) Patent Application Publication
(10) Pub. No.: US 2019/0069145 A1
(43) Pub. Date: Feb. 28, 2019

(54) EMERGENCY RESPONSE USING VOICE AND SENSOR DATA CAPTURE

(71) Applicant: QUALCOMM Incorporated, San Diego, CA (US)

(72) Inventor: Eugene DANTSKER, San Diego, CA (US)

(21) Appl. No.: 15/690,087

(22) Filed: Aug. 29, 2017

(51) Int. Cl. H04W 4/22; H04M 3/51; G10L 15/08; G10L 15/22; G06F 17/24; G10L 15/30; G06F 19/00

(52) U.S. Cl. CPC H04W 4/22; H04M 3/5116; G10L 15/08; G10L 2015/088; G06F 17/241; G10L 15/30; G06F 19/322; G10L 15/22

(57) ABSTRACT

Methods, systems, computer-readable media, and apparatuses for emergency response using voice and sensor data capture are presented. One example method includes transmitting, by a user device, an emergency call request to an emergency services provider; prior to the emergency call request being answered: recording, by the user device, audio signals comprising speech signals; and obtaining one or more keywords from recognized words based on the speech signals; and after detecting an emergency call connection: generating a message to the emergency services provider, the message comprising at least one annotation based on the keywords; and transmitting, by the user device, the message to the emergency services provider

### BACKGROUND

Personal Emergency Response Systems (PERS) may be used by persons who are elderly, disabled, or otherwise at risk of injury from falls or have persistent or acute medical conditions. In a typical scenario, a person activates a PERS device by pressing a button on a small wearable device, which may activate the device itself or another stationary device within their home. Once activated, typically the device contacts a call center, at which point a conversation takes place with the patient (“Are you ok?”, “Are you able to move?” “We are dispatching ambulance”, etc.). The call center then makes a decision based on interaction with the patient (“I've fallen and can't get up”). Similarly, emergency dispatches may be accomplished by calling an emergency telephone number, such as 311. Once an operator answers the call, she may obtain information from the caller regarding the nature and location of the emergency, and dispatch the appropriate responders, e.g., police, ambulance, fire engines, etc.

### BRIEF SUMMARY

Various examples are described for emergency response using voice and sensor data capture.

One example method according to this disclosure includes transmitting, by a user device, an emergency call request to an emergency services provider; prior to the emergency call request being answered: recording, by the user device, audio signals comprising speech signals; and obtaining one or more keywords from recognized words based on the speech signals; and after detecting an emergency call connection: generating a message to the emergency services provider, the message comprising at least one annotation based on the keywords; and transmitting, by the user device, the message to the emergency services provider.

One example device according to this disclosure includes a microphone; a communications network interface; a non-transitory computer-readable medium; and a processor in communication with the microphone, the communications network interface, and the non-transitory computer-readable medium, the processor configured to execute processor-executable instructions stored in the non-transitory computer-readable medium to: transmit, using the communications network interface, an emergency call request to an emergency services provider; prior to the emergency call request being answered: record audio signals obtained by the microphone, the audio signals comprising speech signals; and obtain one or more keywords from recognized words based on the speech signals; after detection of an emergency call connection: generate a message to the emergency services provider, the message comprising at least one annotation based on the keywords; and transmit the message to the emergency services provider.

One example apparatus according to this disclosure includes means for transmitting an emergency call request to an emergency services provider; prior to the emergency call request being answered: means for recording audio signals prior to the emergency call request being answer, the audio signals comprising speech signals; and means for obtaining one or more keywords from recognized words based on the speech signals; means for generating a message to the emergency services provider after detecting an emergency call connection, the message comprising at least one annotation based on the keywords; and means for transmitting the message to the emergency services provider.

One example non-transitory computer-readable medium according to this disclosure includes processor-executable instructions configured to cause a processor to transmit an emergency call request to an emergency services provider; prior to the emergency call request being answered: record audio signals, the audio signals comprising speech signals; and obtain one or more keywords from recognized words based on the speech signals; after detection of an emergency call connection: generate a message to the emergency services provider, the message comprising at least one annotation based on the keywords; and transmit the message to the emergency services provider.

Another example method according to this disclosure includes receiving a message from a user device, the message comprising at least one annotation associated with an emergency condition, the user device associated with an individual; identifying a medical record associated with the individual; and updating the medical record based on the emergency condition.

Another example device according to this disclosure includes a communications network interface; a non-transitory computer-readable medium; and a processor in communication with the communications network interface and the non-transitory computer-readable medium, the processor configured to execute processor-executable instructions stored in the non-transitory computer-readable medium to: receive a message from a user device using the communications network interface, the message comprising at least one annotation associated with an emergency condition, the user device associated with an individual; identify a medical record associated with the individual; and update the medical record based on the emergency condition.

Another example apparatus according to this disclosure includes means for receiving a message from a user device, the message comprising at least one annotation associated with an emergency condition, the user device associated with an individual; means for identifying a medical record associated with the individual; and means for updating the medical record based on the emergency condition.

Another example non-transitory computer-readable medium according to this disclosure includes processor-executable instructions configured to cause a processor to receive a message from a user device using the communications network interface, the message comprising at least one annotation associated with an emergency condition, the user device associated with an individual; identify a medical record associated with the individual; and update the medical record based on the emergency condition.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for emergency response using voice and sensor data capture;

FIG. 3 shows an example computing device for emergency response using voice and sensor data capture;

FIG. 4 shows an example method for emergency response using voice and sensor data capture;

FIG. 5 shows an example bar chart representing a ranking of emergency conditions based on respective probability scores for each emergency condition represented along the X-axis of the bar chart; and

FIGS. 6-7 show example methods for emergency response using voice and sensor data capture.

### DETAILED DESCRIPTION

Examples are described herein in the context of emergency response using voice and sensor data capture. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

A PERS, 911, or other emergency response service (“ERS”) may receive voice calls from subscribers or other users when an emergency situation unfolds. Emergencies can be health-related, crime-related, etc. However, when an individual contacts an ERS, there is a time delay between the initiation of the communication and when the ERS begins communicating with the individual. During this interval, crucial information about the emergency may be available for capture or detection; however, such information is lost by the time the ERS communication begins. For example, the user may utter words or phrases relating to the emergency or a cause of the emergency, or aspects of the user's speech or even of environmental sounds, may be lost if not captured.

In an illustrative example of emergency response using voice and sensor data capture, when an individual initiates a communication to an ERS with a user device, such as by dialing 911 (or 999, or another emergency response number), or activating a dedicated PERS device, the user device detects the emergency communication and immediately activates a microphone within the user device and begins recording audio signals. In addition, the user device may also begin recording sensor information from one or more sensors within the user device, worn by the user, or available in proximity to the individual or the user device.

In this example, the user device records audio signals and performs speech recognition on the received audio signals as soon as the individual initiates the communication. During this time the individual may utter words, phrases, or sounds that indicate characteristics of the emergency, such as the cause of the emergency, the nature of the emergency, the individual's location, identify other individuals who are present, etc. For example, she may describe symptoms, what happened, or may make nonverbal noises. The audio data, which may include voice data, is recorded and processed to identify information relevant to the emergency. For example, if the individual falls and breaks her hip, she may press a button on a device and immediately begin describing what happened—“I've fallen and my hip really hurts” or the device may detect the emergency based on recorded audio of sounds indicative of a fall or other event. The individual's speech may be prompted by the device or it may simply record anything the individual says as they talk following the event. This recorded speech may be provided to a speech recognition technique to recognize words or phrases uttered by the individual.

The speech recognition output is then searched for particular keywords or phrases. When such keywords or phrases are identified, they are used to generate a message to the ERS and are embedded within the message as “annotations.” Annotations in this context refers to any incorporation of keywords or other indicia relating to the emergency, such as the cause of the emergency, nature of the emergency, etc. Thus, the message may be constructed with logistical information, such as date, time, the individual's name, the individual's location, as well as the annotation(s) obtained from the recognized speech.

In addition, the audio signals may be provided to a sound recognition technique that can recognize sounds, such as groans, breaking glass, gunshots, etc. Annotations may then also be generated based on any recognized sounds and likewise incorporated into the message. For example, the sound recognition may identify sounds, such as groans, but the user device may generate an annotation indicating “pain” corresponding to the detected groan, or may generate an annotation indicating “sleep” corresponding to detected deep breathing. Further, the user device may be equipped with one or more sensors, or be in communication with such sensors, and so such sensor information may be incorporated into one or more of the messages.

Once the ERS is contacted and the user device is communicating with it, the user device transmits the message to the ERS, where it may be autonomously processed by the ERS to identify the nature of the emergency and a default response protocol for such an emergency. In addition, the ERS may modify the default response protocol based on the annotations. For example, the annotations may indicate that the individual is having a heart attack, but also that the individual is a known opiate user. Thus, the default response protocol may be modified to notify any emergency responders to be ready to administer one or more doses of Narcan® or similar overdose drug.

In addition, during the course of the communication, the user device continues to record audio signals, as well as obtain information from other sensors, such as pulse rate, respiratory rate, etc. The user device may continue to recognize keywords or phrases from the individual's recorded speech, which may be used to generate one or more subsequent messages including further annotations, sensor information, etc., that may be provided to the ERS, which may then further modify the emergency response protocol. The user device may also access medical information about the user, such as emergency medical information stored on the user device, or electronic health records (“EHR”) available from a health care provider. Such information, such as information about chronic medical conditions, drug prescriptions, etc. may also be used to determine the likely emergency condition, or may be incorporated into one or more messages.

In this example, the user device also transmits a message to the individual's cardiologist indicating that the individual appears to have suffered a heart attack, or to the individual's spouse, who may be notified to return home to help the individual. Still further messages may be transmitted to other third parties based on the nature of the emergency, such as the individual's doctor, health care provider, or even to a clinical research organization if the individual is participating in a clinical trial.

This illustrative example is given to introduce the reader to the general subject matter discussed herein and the disclosure is not limited to this example. The following sections describe various additional non-limiting examples and examples of systems and methods for emergency response using voice and sensor data capture.

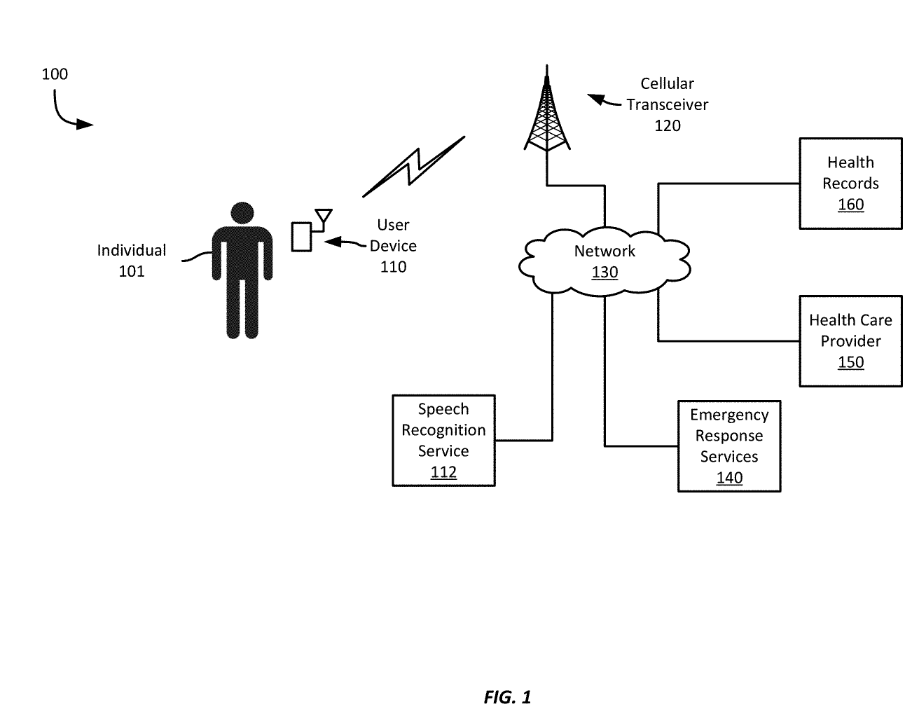

Referring now to FIG. 1, FIG. 1 shows an example environment 100 for emergency response using voice and sensor data capture. The environment 100 includes an individual 101, who has a user device 110. The user device 110 in this example is a cellular device and can employ a cellular network to make and receive cellular phone calls, browse web pages on the internet, etc. To provide such functionality, the user device 110 is connected to a cellular transceiver 120, which provides access to network 130, which in turn provides access to various other devices and systems. In this example, a speech recognition service 112 is available via the network 130, as are an ERS provider or system 140, a health care provider 150, and the individual's health records 160, which are stored in a cloud storage medium.

In the event the individual 101 experiences an emergency condition, such as a health emergency, she may contact ERS system 140 by dialing an emergency number, such as 911, or by pressing a button to activate a PERS device. After the user dials the emergency number, the user device 110 activates its microphone, and in some examples other sensors, such as the camera, accelerometer, etc., and begins recording audio signals. The user device 110 then streams the audio signals to the speech recognition service 112 via the cellular transceiver 120 and the network 130. In response, the user device 110 receives a stream of recognized words from the speech recognition system 112. In some examples, the speech recognition system 112 may also provide additional information, such as indications of slurred speech, broken speech, or other characteristics of the speech that may be indicative of an emergency condition.

When receiving the recognized words from the speech recognition system 112, the user device 110 obtains keywords, which includes key phrases, from the recognized words. After obtaining the keywords, the user device 110 may generate a message to send to the ERS system 140 that includes the keywords, referred to as “annotations” once they have been incorporated into a message, and in some examples, the message may also include the recorded audio signals or one or more identified emergency situations. Further, since multiple keywords may be Obtained over a period of time before the call is answered, the user device 110 may continue to incorporate information into the message, or generate multiple messages, until the call is answered.

In some examples, the user device 110 may attempt to determine the emergency experienced by the individual 101. The user device 110 may be preconfigured with one or more templates associated with different emergency conditions, and the templates may include keywords associated with the respective emergency condition. Thus, a template for a heart attack emergency may include keywords such as “left arm,” “tingling,” “weight on chest,” “chest pain,” etc. Further, keywords may include regular expressions or other keyword templates since one user experiencing an emergency may not always use the same phrasing as another. For example, keywords may be represented as regular expressions, such as “*left*arm” or “weight*chest” or “chest*weight.” Thus, a template for an emergency condition may be flexible and encompass a wide range of possible keywords.

To detect an emergency situation, the user device 110 may compare the obtained keyword(s) against emergency condition templates to determine a probability that a particular template corresponds to the individual's emergency. For example, each template may include not only keywords but also weighting information such that when one or more keywords are identified, a score can be calculated for the template using the weights. The scores for the various templates accessed by the user device 110 can then be compared or ranked to identify the highest score. The emergency associated with the identified template may then be incorporated into the message.

Some examples may employ a machine learning (“ML”) technique or engine to determine an emergency condition based on the obtained keywords, or from sensor data obtained from the user device 110 or other devices connected to the user device 110, such as medical devices or sensors. The ML technique may be trained to recognize certain emergencies based on certain keywords, sensor data, or vocalizations, e.g., groans, breathing noises, etc. Thus, the obtained keywords may be provided to the ML technique, which may determine a likely emergency condition. Further, the ML technique may be iteratively executed over time as new keywords or sensor information is obtained.

In some examples, in addition to obtaining keywords from the recognized words, the user device 110 may obtain one or more health records associated with the individual 101. For example, the user device 110 may access or obtain one or more of the individual's EHRs from the health records system 160. The EHRs may include information such as chronic health problems, recent significant health events (e.g., surgeries, heart attacks, strokes, broken bones, etc.), allergies, drug prescriptions, etc. Information obtained from the EHRs may be employed in conjunction with the obtained keywords to help determine the emergency confronting the individual or may be provided to the ERS system 140 in one or more messages.

After the emergency call from the user device 110 connects to the ERS system 140, the user device 110 transmits any messages that have been generated to the ERS system 140, which may then use the information within the message in any number of ways. In one example, the ERS system 140 may use the message(s) to provide additional contextual information to a dispatcher. In some examples, the message(s) may be used to access a predefined emergency response template, or to modify a standard emergency response. For example, if the ERS system 140 dispatches an ambulance, information from the message may be used to instruct the emergency personnel to charge a defibrillator, prepare a dose of Narcan®, or to notify an emergency room at a hospital about a potential stroke victim, etc. In some examples, the message(s) may be used to automatically dispatch emergency services.

In addition, after the emergency call from the user device 110 has been established with the ERS system 140, the user device 110 may continue to record audio signals and obtain keywords. Such functionality may be employed to assist when the ERS system 140 has difficulty hearing or understanding the user, such as due to a poor quality audio connection, or if the call to the ERS system 140 is interrupted and must be redialed, or during an idle period of a connected call, such as if the individual 101 is put on hold. The user device 110 may still be able to obtain keywords and transmit messages with annotations to the ERS system 140, or to provide the recorded audio signals, which may help ensure the ERS system 140 is provided with as much information about the individual's emergency as possible.

In this example, the ERS system 140 is a 911 system that provides emergency services to any member of the public, and may dispatch fire, police, or medical emergency responders. However, in some examples, the ERS system 140 may be a proprietary ERS system operated by a company or health care provider. For example, the individual 101 may subscribe to a PERS provider, which supplies a wearable device for the individual to wear and a PERS hub that is positioned within the individual's residence. If the user activates the wearable device, it transmits an emergency request to the PERS hub, which in turn generates an emergency request to the PERS provider. The PERS provider may then respond to the call as discussed herein.

In some examples, in addition to contacting an ERS system 140, the user device 110 may transmit one or more messages to one or more third parties, such as the individual's health care providers, including a doctor's office, a specialist's office, a hospital, a clinical research organization (“CRO”), etc. The message transmitted to the third parties can be the same message(s) that were sent to the ERS system 140 or may include different information, such as the patient's location, which may have already been provided to the ERS system 140 through another mechanism, e.g., E911; a patient identifier e.g., if the patient is a participant in a clinical trial;, etc.

Thus, the system 100 shown in FIG. 1 provides with a robust system by which as much information can be gathered about an individual's emergency, which can be provided to an ERS system 140. The system 100 allows such information to be gathered, even without an established connection with the ERS system 140. Thus, the system 100 may enable the ERS system to tailor its response to the individual's specific emergency and needs.

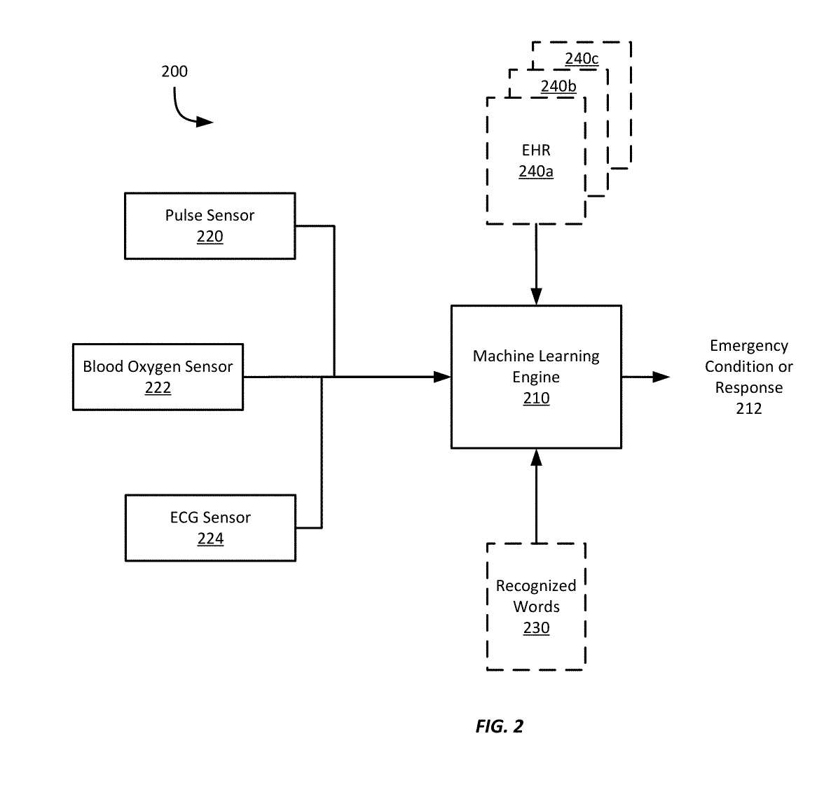

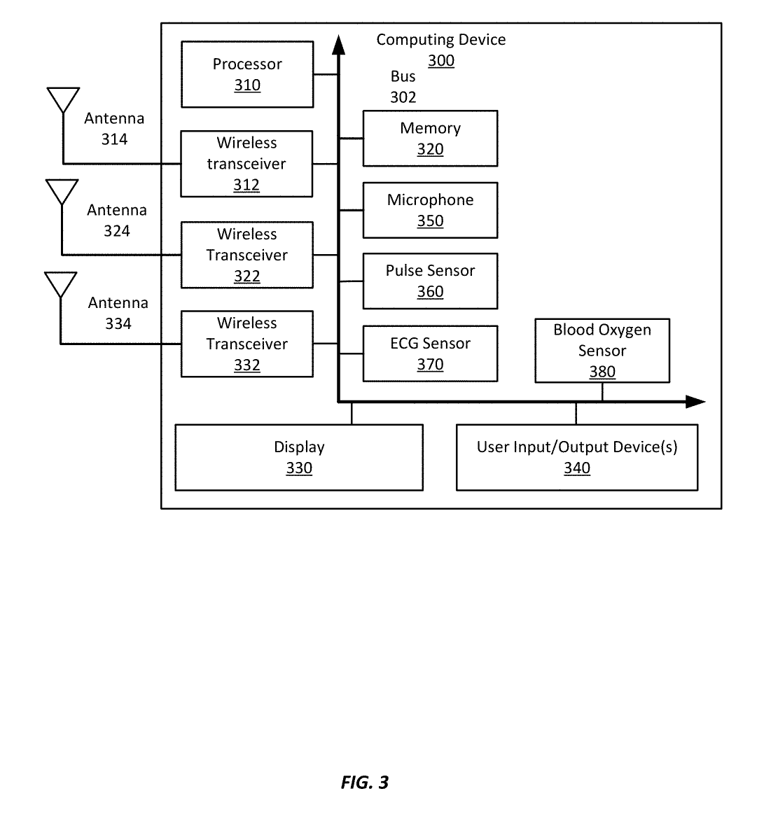

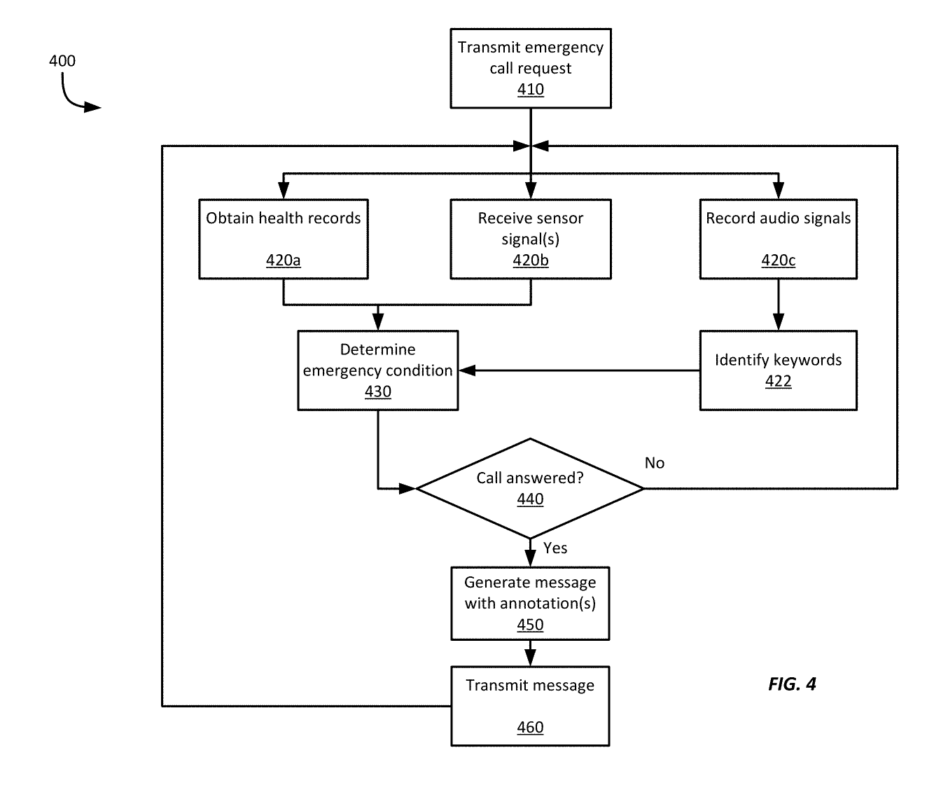

Referring now to FIG. 2, shows an example system 200 for emergency response using voice and sensor data capture. In this example, the system 200 is embodied in one or more computing devices or wearable computing devices, which will be discussed in more detail with respect to FIGS. 3-4 below. The system 200 includes multiple sensors that provide sensor information to a trained machine learning (“ML”) engine 210. The trained Mt engine 210 uses the received information to generate an emergency condition 212. The emergency condition 212 may then be communicated to an ERS system, such as the ERS system 140 shown in FIG. 1.

As discussed above, the trained ML engine can receive recognized words generated by a speech recognition technique, such as recognized words received from a speech recognition service 112. The ML engine 210 in this example has been trained using labelled sensor data sets generated based on typical characteristics of different emergency situations. For example, keywords and sequences of keywords associated with different health emergencies may be grouped together and provided as a training set to the ML engine 210 along with the associated emergency condition. Other types of emergency situations, such as crimes, fires, floods, vehicle accidents, etc., may be trained in similar ways to establish a trained ML engine 210. Suitable training techniques may include supervised training techniques or continuous optimization techniques. During training in this example, outputted emergency conditions by the ML engine 210 may be compared against the desired output and any errors in the output may be fed back into the ML engine 210 to modify the ML engine 210. Once it has been trained, the trained ML engine 210 receives sensor information from one or more of the sensors and applies the sensor information to a trained ML technique associated with the patient to generate a micro activity 212 and a macro activity 214. Any suitable ML technique may be employed according to different examples.

In addition, the example system 200 can employ one or more EHRs 240a-c for an individual, and also includes a pulse sensor 220, a blood oxygen sensor 222, and an ECG sensor 224. Other sensors or types of sensors may be employed according to different examples. The sensors may be incorporated into one or more computing devices or may be separate and discrete from any of an individual's computing devices. For example, the individual may wear one or more ECG sensors affixed to their skin, which may then communicate via wired or wireless communications techniques with a computing devices. Thus, the system 200 show in FIG. 2 may be embodied within a single device, or may be distributed amongst multiple interconnected devices.

The various sensors shown in FIG. 2 transmit sensor information to the trained ML engine 210, though one or more of the signals may be filtered or otherwise processed prior to being provided to the trained ML engine 210. For example, the pulse sensor 220 may detect an individual's pulse using any suitable pulse sensor, such as using infrared light emitters and detectors. The pulse sensor 220 may then provide to the trained ML engine 210 any related information according to different examples, such as pulse rate, individual pulses (with or without time stamps), pulse characteristics, pulse wave velocity, etc. Alternatively, the pulse sensor 220 may provide raw output from one or more of the detectors, which may then be processed by the trained ML engine 210 or another technique to obtain the relevant pulse information. Similarly, other sensors may provide raw, filtered, or processed sensor information to the trained ML engine 210.

In this example, the trained ML engine 210 is executed at the ERS system 140 and can accept information received from user devices, including recognized words, information obtained from sensors within the user device or otherwise in communication with the individual. In addition, the trained ML engine can accept EHRs, portions of EHRs provided by the individual, information extracted from one or more EHRs or, in some examples, the trained ML engine may request one or more EHRs, or information from one or more EHRs, from a health care provider. The trained ML engine 210 then processes the received inputs to determine an emergency response procedure 212, or to modify an existing emergency response procedure 212.

For example, an ERS system 140 may employ a default emergency response of dispatching police, a fire engine, and ambulance if an emergency call is received but no information is provided. If the ERS system 140 is informed of a medical emergency, but no further details are provided, the ERS system 140 may default to dispatching an ambulance. But, using the example system 200 of FIG. 2, the ERS system 140 accepts the recognized words 230 from the user device and determines a nature of the emergency, e.g., the specific medical or health problem, and can modify the response to dispatch an ambulance from a hospital with a trauma center or with a cardiologist on call. In some examples, the trained ML engine 210 can also generate information to be provided to the responding personnel, such as specific equipment or medications that may be needed, such as charging a defibrillator, preparing doses of medication or painkillers, etc. Thus, the trained ML engine 210 can modify or tailor an emergency response procedure based on the specific information obtained about a particular emergency.

In some examples, however, a trained ML engine 210 may be executed by a user device to determine an emergency condition. The trained ML engine 210 accepts the recognized words as inputs. In some examples, it may also accept sensor or EHR information that may be provided or available. The trained ML engine 210 can then determine the most likely emergency condition 212, or probabilities associated with multiple emergency conditions, and the user device can provide the emergency condition 212 to an ERS system.

Referring now to FIG. 3, FIG. 3 shows an example computing device 300 for emergency response using voice and sensor data capture. The example computing device 300 includes a processor 310, memory 320, a display 330, user input and output devices 340, a microphone 350, a pulse sensor 360, an ECG sensor 370, and a blood oxygen sensor 380 in communication with each other via bus 302. In addition, the computing device 300 includes three wireless transceivers 312, 322, 332 and associated antennas 314, 324, 334. The processor 310 is configured to execute processor-executable program code stored in the memory 320 to execute one or more methods for emergency response using voice and sensor data capture according to this disclosure.

In this example, the computing device 300 is a smartphone. However, the computing device may be any computing device configured to receive sensor signals and communicate with an ERS system, such as ERS system 140. In example, the computing device 300 is a wearable device that integrates as a part of a PERS. In one example, the wearable computing device may communicate directly with an ERS system 140; however, in some examples, the wearable computing device may communicate with a PERS hub located within the individual's residence. The PERS hub may then relay a transmitted emergency request to an ERS system, which may then establish communications with the PERS hub or directly with the PERS device.

Other examples of suitable computing devices according to this disclosure include laptop computers, desktop computers, tablets, phablets, satellite phones, cellular phones, dedicated video conferencing equipment, IOT hubs, virtual assistant devices (such as Alexa®, Home®, etc.), wearable devices (such as smart watches, earbuds, headphones, Google Glass®, etc.), etc. Further, in some examples, the computing device 300 may not include sensors, but instead may operate as a computing device, such as a server, for an ERS system, at a health care provider, etc.

In this example, the smartphone 300 is equipped with a wireless transceiver 312, 322, 332 and corresponding antennas 314,324, 334 configured to wirelessly communicate using any suitable wireless technology with any device, system or network that is capable of transmitting and receiving RF signals according to any of the IEEE 16.11 standards, or any of the IEEE 802.11 standards, the BT standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology. In addition, one or more transceivers 312, 322, 332 may be configured as, or replaced by, a GNSS receiver, such as a GPS receiver.

While the example computing device 300 shown in FIG. 3 employs wireless communication techniques, in some examples, the example computing device 300 may employ one or more wired communication techniques, including traditional POTS (plain old telephone system), to transmit a call request to an ERS system 140.

Example computing devices 300 may also be configured to operate as ERS systems 140, though in such configurations, they may not include the sensors shown in FIG. 3, or may include one or more wired network interfaces, which may include one or more POTS interfaces.

Referring now to FIG. 4, FIG. 4 shows an example method 400 for emergency response using voice and sensor data capture. The method 400 of FIG. 4 will be discussed with respect to the system 100 shown in FIG. 1 and the example computing device 300 shown in FIG. 3. However, it should be appreciated that any suitable system or computing device according to this disclosure may be employed according to different examples.

At block 410, a user device 110 transmits an emergency call request to an emergency services provider, such as the ERS system 140 of FIG. 1. In this example, the individual 101 dials 911 on their smartphone; however, in some examples, the individual 101 may generate and transmit a text or short message service (“SMS”) message to 911 or other emergency number. In some examples, the user device 101 may be a PERS component, such as a wearable device, where the wearable device transmits an emergency call request to a PERS hub in the individual's residence, which in turn transmits an emergency call request to the ERS system 140. Means for performing the functionality described with respect to blocks 420a-c may include the user device 110, one or more of the wireless transceivers 312-332 and antennas 314-334, or the example computing device 300 described above with respect to FIGS. 1-3.

The method 400 proceeds to at least block 420c, but may also substantially simultaneously proceed to one or more of blocks 420a or 420b depending on available sensors or health records. Further, it should be appreciated that the method 400 may proceed to block(s) 420a-c before the emergency call request has actually been transmitted. For example, if the user dials 911 and presses a ‘dial’ or ‘begin call’ icon to initiate the emergency call, the user device 110 may detect the emergency number being dialed prior to the user actually initiating the call. In such an example, the method 400 may proceed immediately to blocks 420a-c as appropriate. Further, if the user dials the emergency number but fails to initiate the call, the user device 110 may autonomously initiate the call without further input from the individual. For example, if, at block 430, the user device 110 detects an emergency condition and determines that the call was not initiated, the user device 110 may autonomously transmit an emergency call request while continuing to perform an example method according to this disclosure. In some examples, however, the user may inadvertently begin dialing an emergency number, but cancels the call—e.g., the user dials 911 instead of 919. In such an example, the user device may terminate the method 400 after determining that an emergency call has not been made.

At block 420a, the user device 110 receives one or more sensor signals from one or more sensors. For example, the user device 110 may include or be in communication with one or more physiological sensors, such as a pulse sensor 360, an ECG sensor 370, a blood oxygen sensor 380, etc. Sensor information received from the one or more sensors may be stored or provided as input to a trained ML engine, or may be incorporated into one or more messages to be provided to an ERS system 140. However, if no sensors are available on the user device 110 or none are in communication with the user device 110, block 420a may be skipped or not included according to some examples.

At block 420b, the user device 110 obtains one or more health or medical records, such as one or more EHRs, for the individual 101. In this example, the user device 110 obtains one or more EHRs from the health records 160 cloud storage area. In some examples, the user device 110 may maintain copies of health records stored in memory 320, or may maintain summary information obtained from previously-obtained health records or from medical information previously entered into the user device 110, such as identifications of any chronic health issues, prescriptions, allergies, blood type information, emergency contacts, etc., for access while copies of one or more EHRs are obtained.

At block 420c, the user device 110 activates one or more microphones on the user device 110 and begins recording audio signals. Recorded audio signals may include environmental sounds, words spoken by the individual 101 or other people nearby, noises made by the individual 101, etc. The recorded audio signals may then be stored in the user device's memory 320. In some examples, the recorded audio signals may be encoded or compressed and transmitted to a speech recognition service 112, or may be provided to a speech recognition technique executed by the user device 110. Suitable speech recognition techniques according to different examples may employ neural networks, including deep neural networks; hidden Markov models (“HMM”); spectral or cepstral analysis techniques; dynamic time warping techniques; etc. Further in some examples, the recorded audio signals may be provided to both of a speech recognition service 112 and to a speech recognition technique executed by the user device 110.

Suitable encoding or compression techniques for compressing audio signals include any known audio or speech coding technique, including industry-standard half-rate codec (“HR”), full-rate codec (“FR”), enhanced full-rate code (“EFR”), adaptive multi-rate codec (“AMR”), MPEG-1 Audio Layer 3 (“MP3”) technique, etc.

Means for performing the functionality described with respect to blocks 420a-c may include the user device 110, the speech recognition service 112, one or more sensors, or the example computing device 300 described above with respect to FIGS. 1-3.

At block 422, the user device 110 identifies one or more keywords based on recognized words from the speech recognition technique. In this example, the user device 110 receives recognized words from the speech recognition service 112 and identifies keywords from the received recognized words. To do so, the user device 110 accesses one or more templates associated with different emergency conditions that may indicate words or phrases associated with the emergency condition. In some examples, however, the user device 110 may be provided with a list of keywords or phrases rather than templates for emergency conditions. For any matches, the user device 110 may store records indicating the identified keyword(s). Means for performing the functionality described with respect to block 422 may include the user device 110 or the example computing device 300 described above with respect to FIGS. 1-3.

At block 430, the user device 110 determines an emergency condition based on the identified keywords. If health record information from block 420a or sensor information from block 420b is available, the user device 110 may determine an emergency condition based on the identified keywords and either or both of the health record information or the sensor information. In this example, the user device 110 executes a trained ML technique 210 to determine one or more emergency conditions. However, in some examples, the user device 110 may determine one or more emergency conditions by determining probabilities associated with one or more emergency conditions.

In one example, the user device 110 may determine a probability of an emergency condition based on a template associated with the emergency condition. For example, the user device 110 may access a template and determine identified keywords from block 422 that correspond to words and phrases identified by the template. The user device 110 may then access weighting information from the template associated with the word and phrases that corresponded to identified keywords and calculate a probability score associated with the emergency condition. The user device 110 may then calculate a probability score for one or more other emergency conditions and rank the emergency conditions based on the probability scores.

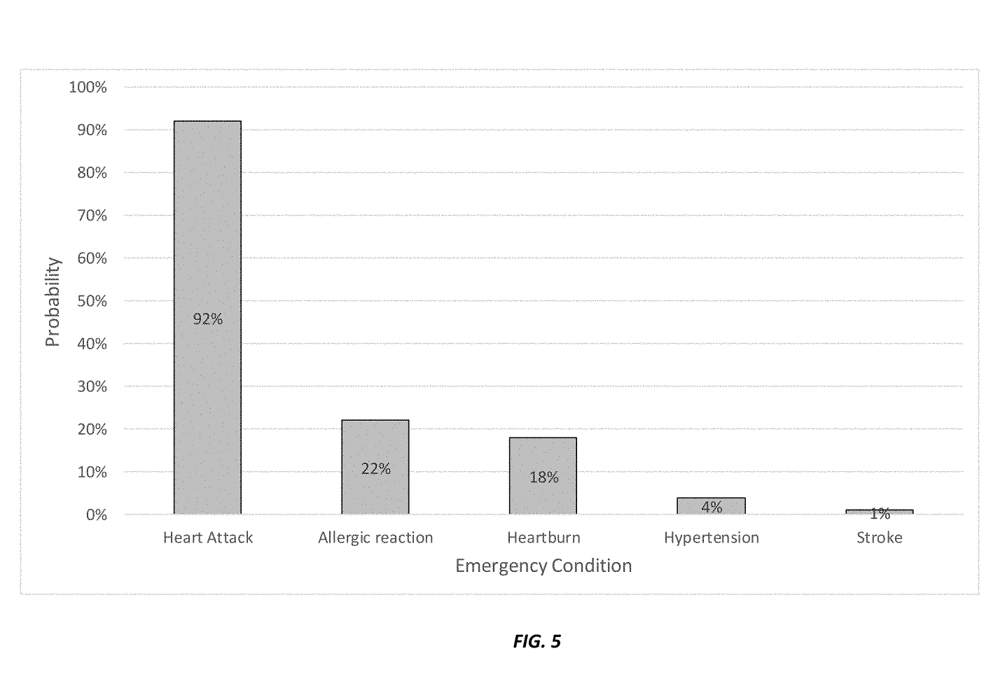

Referring now to FIG. 5, FIG. 5 shows a bar chart representing a ranking of emergency conditions based on respective probability scores for each emergency condition represented along the X-axis of the bar chart. It should be noted that the probabilities represent the probability that the specific emergency condition is detected, thus, the total probability scores for all emergency conditions may sum to a total greater than (or less than) 100% in different examples. In this example, as can be seen, the heart attack emergency condition has a probability of 92%, while the next highest probability of 22% is associated with an allergic reaction. Thus, in this example, the user device 110 may identify the emergency condition as a heart attack. In some examples, though, if multiple emergency conditions have probabilities greater than a reference threshold, such as 75%, the user device 110 may identify each of the emergency conditions. In general, a user may experience multiple emergencies at the same time, and so identifying multiple emergency conditions, e.g., a stroke and a fall, may be desirable in some examples.

Referring again to FIG. 4, in some examples, the user device 110 may not determine an emergency condition and thus may not execute or may not include functionality associated with block 430. For example, a user device 110 may identify keywords from the recognized words and provide the identified keywords to one or more third parties, such as the ERS system 140 or to one or more health care providers 150. Means for performing the functionality described with respect to block 430 may include the trained ML engine 210, the user device 110, or the example computing device 300 described above with respect to FIGS. 1-3.

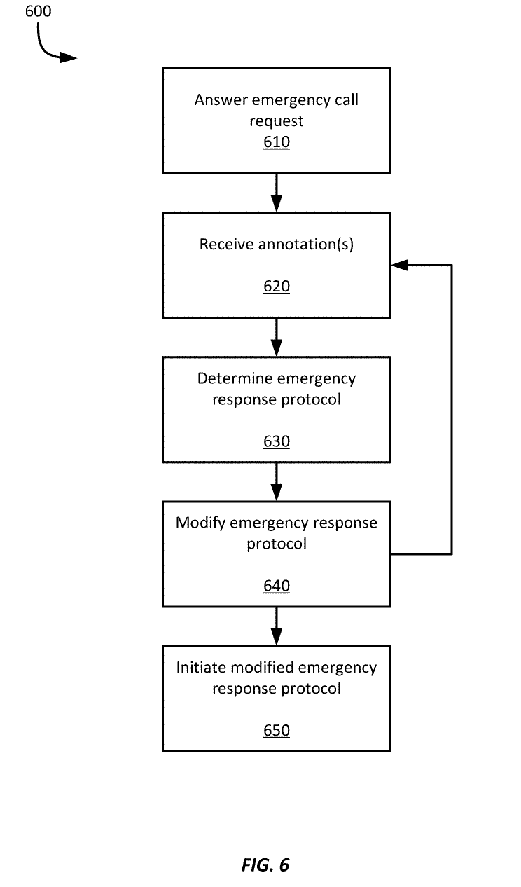

In some examples, however, the user device 110 may not determine an emergency condition, thus some example methods according to this disclosure may not include a corresponding block 430. For example, the user device 110 may transmit one or more messages to an ERS system, which may then determine an emergency condition, such as described below with respect to the method 600 of FIGS. 6.

At block 440, the user device 110 determines whether the emergency call request has been answered and call has been connected. If so, the method 400 proceeds to block 450; otherwise it returns to block(s) 420a-420c.

At block 450, the user device 110 generates a message to the ERS system 140 including the identified keywords. In this example, the device only includes the identified keywords as annotations. In some examples, however, the user device 110 may generate a message having information other than the annotations. For example, the message may include information about the individual, such as the individual's name; the individual's address; one or more telephone numbers for the individual; information about immediate family or other residents at the individual's address; the individual's location, which may include geographic location such as from a GLASS receiver, a name of a business, etc.; the individual's doctor(s)'s name(s), including a primary physician, one or more specialists, one or more surgeons, etc. In addition to information about the individual, the message may include some or all of the health record information obtained at block 420a or some or all of the sensor information obtained at block 420b. If the user device 110 has determined one or more emergency conditions at block 430, such emergency conditions may be incorporated into the message as well. In some examples, the message may also include the recorded audio signals, which may be encoded as discussed above with respect to block 420c.

Means for performing the functionality described with respect to block 450 may include the user device 110, or the example computing device 300 described above with respect to FIGS. 1-3.

At block 460, the user device 110 transmits the message to the ERS system 140 after the call is connected. In some examples, the user device 110 may transmit the message to other third parties as well, such as a health care provider, a hospital, one or more of the individual's family members, etc.

Means for performing the functionality described with respect to block 460 may include the user device 110, the example computing device 300, or one or more wireless transceivers 312-332 or antennas 314-334 described above with respect to FIGS. 1-3.

The method 400 may then return to blocks 420a-c. It should be appreciated that, while the user device 110 is performing the described functionality with respect to blocks 440-460, the user device 110 may continue to perform the functionality at blocks 420a-c, 422, and 430. Thus, after transmitting the message at block 460, while FIG. 4 shows the method returning to a point before blocks 420a-c, those blocks may continue operating uninterrupted irrespective of the functionality of blocks 440-460. Thus, the user device 110 may continue, even after the emergency call is answered, to collect health record information, receive sensor signals, and record audio signals, and subsequently generate one or more additional messages, which may be transmitted to the ERS system 140 or to one or more other third parties.

Referring now to FIG. 6, FIG. 6 shows an example method 600 for emergency response using voice and sensor data capture. In this example, the method 600 is performed by the autonomous ERS system 140 shown in FIG. 1, and will be discussed with respect to the system 100 shown in FIG. 1; however, any suitable system according to this disclosure may be employed.

At block 610, the ERS system 140 answers an emergency services call from a user device 110. In this example, the ERS system 140 is connected to a telephone system, such as POTS, and receives the emergency services call as a traditional telephone call; however, in some examples, the ERS system 140 may receive a call according to other communication techniques, including text or SMS messages, a video conferencing call, etc. Means for performing the functionality described with respect to block 610 may include the example computing device 300, one or more wireless transceivers 312-332 or antennas 314-334, or one or more wired network interfaces described above with respect to FIGS. 1-3

At block 620, the ERS system 140 receives a message from the user device 110 that includes at least one annotation associated with an emergency condition. In this example, the annotation(s) include one or more keywords obtained generally as described above with respect to block 422 of the method 400 of FIG. 4. In some examples, however, the message may include other information, such as generally described above with respect to block 422 of the method 400 of FIG. 4.

After receiving the message, the ERS system 140 extracts information from the message and, in some examples, displays some or all of the information from the message on a display screen, such as a display screen for a human ERS operator. In some examples, the information from the message is used to autonomously determine an emergency condition or emergency response protocol generally as described below with respect to block 630. Means for performing the functionality described with respect to block 620 may include the example computing device 300 described above with respect to FIGS. 1-3

At block 630, the ERS system 140 determines an emergency response protocol based on the received message. In this example, the ERS system 140 employs a human operator who determines an emergency based on information obtained from the individual 101 during the emergency call, as well as based on information received from the received message. For example, the individual 101 may tell the operator that he is having trouble breathing and that his arm is tingling. In addition, the operator's display screen may display one or more of the annotations from the message, such as “chest pain.” The operator may confirm such information with the individual, or may simply employ the information to determine an emergency condition.

In some examples, however, the ERS system 140 may employ a trained ML engine 210 to determine an emergency condition generally as discussed above with respect to block 430 of the method 400 of FIG. 4, and to select an emergency response protocol. In this example, the ERS system 140 maintains one or more default emergency response protocols for different types of emergencies, such as medical emergencies, crime emergencies, fire emergencies, etc. For example, an emergency response protocol for a fire emergency may include dispatching two fire engines and an ambulance to the caller's location, while a crime emergency may include dispatching two police cars, a fire engine, and an ambulance to the caller's location. In this example, the determined emergency is a heart attack. The ERS system 140 classifies heart attacks as medical emergencies, and so selects the default medical emergency protocol,

Means for performing the functionality described with respect to block 630 may include the example computing device 300 described above with respect to FIGS. 1-3.

At block 640, the ERS system 140 modifies the emergency response protocol for the emergency condition based on one or more annotation from a received message. In this example, the trained ML engine 210 has determined the emergency condition as being a heart attack. Thus, the ERS system 140 modifies the default emergency protocol to select an ambulance or health care provider specially equipped to treat heart attack victims. The ERS system 140 then generates a dispatch message to the selected entity, and includes heart attack-specific instructions, such as “dispatch with defibrillator” and “page cardiologist,”

In an example involving a crime emergency, the ERS system 140 may modify a default emergency response protocol to indicate particulars of the crime, such as “shooting” or “domestic violence” or “burglary,” and further may adjust the number or type of police vehicles dispatched. For example, for a “shooting” emergency, the ERS system 140 may modify the default emergency response protocol to dispatch four police cars and a police helicopter, as well as two ambulances to assist with injuries. The default emergency response protocol may be further amended to provide a notification to one or more hospitals of the shooting and to page one or more emergency room personnel, e.g., surgeons, to treat injured persons.

Means for performing the functionality described with respect to block 640 may include the example computing device 300 described above with respect to FIGS. 1-3.

At block 650, the ERS system 140 initiates the modified emergency response protocol. In this example, the ERS system 140 initiates the modified emergency response protocol by issuing dispatch notifications to the selected hospital or ambulance service that includes the additional heart attack-specific instructions. In some examples, the ERS system 140 may also transmit a notification to one or more third-party entities, such as a hospital emergency room associated with the selected hospital or ambulance service to notify it of the incoming heart attack patient. The ERS system 140 may transmit a notification to one or more health care providers 150 associated with the individual 101, or to a CRO related to a clinical trial the individual 101 is associated with.

In the case of a crime or fire emergency, the ERS system 140 may autonomously select a fire station or police department within a threshold distance of the location of the emergency, and autonomously transmit a dispatch notification to the selected fire station or police department including the specific instructions for the emergency condition as discussed above.

Means for performing the functionality described with respect to block 650 may include the example computing device 300, one or more wireless transceivers 312-332 or antennas 314-334, or one or more wired network interfaces described above with respect to FIGS. 1-3.

In some examples, in addition to performing the blocks discussed above, the method 600 may also further train or refine the ML engine 210, such as by providing a putting the ML engine 210 into a training mode, feeding the relevant sensor information into the ML engine 210 along with the appropriate emergency condition, such as the emergency condition that was determined in the course of performing the method 600. In some such examples, the ML engine 210 may continue to refine itself.

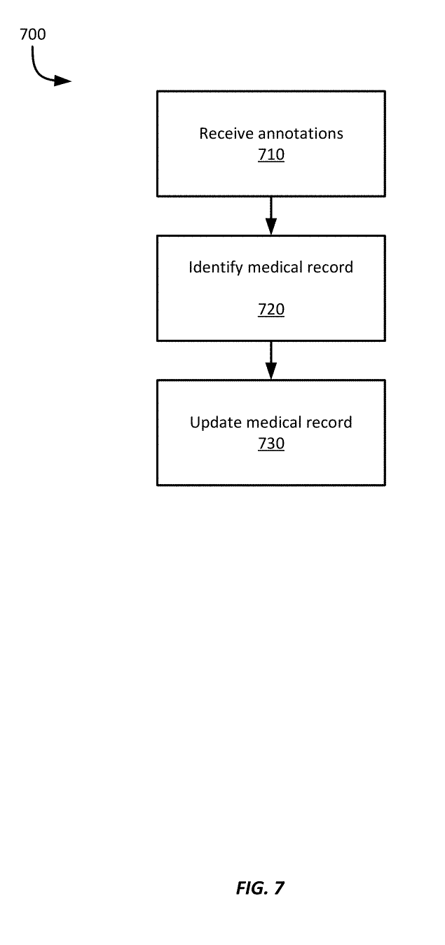

Referring now to FIG. 7, FIG. 7 illustrates an example method 700 for emergency response using voice and sensor data capture. This example method 700 will be described with respect to the system 100 of FIG. 1; however it should be understood that any suitable system according to this disclosure may be employed.

At block 710, a health care provider receives a message from a user device, where the message includes at least one annotation associated with an emergency condition. In this example, the individual 101 has configured her user device 110, a smartphone, to notify her cardiologist of any medical emergencies. Thus, in this example, the health care provider 150, the individual's 110 cardiologist's office, receives the message from the individual's smartphone 110. The message includes one or more annotations indicating heart attack-related annotations, such as “chest pain” and “left arm tingling.” In this example, the health care provider 150 executes a trained ML engine 210 that receives the annotations and determines an emergency condition generally as described with respect to block 430 of the method 400 of FIG. 4. Thus, the health care provider 150 determines that the individual 101 has likely suffered a heart attack. In some examples, however, the message may include an identification of the emergency condition, such as determined by the user device 101.

In some examples, the health care provider 150 may receive one or more messages having annotations from an ERS system 140. For example, the ERS system 140 may generate and provide a message to the health care provider 150 indicating the emergency condition, information about the individual 101, information related to the modified emergency response protocol, such as an identification of a hospital or other health care provider that received or admitted the individual, the name of an attending doctor, etc. Such information may be provided instead of, or in addition to, one or more messages received from the user device 110.

Means for performing the functionality described with respect to block 710 may include the example computing device 300, one or more wireless transceivers 312-332 or antennas 314-334, or one or more wired network interfaces described above with respect to FIGS. 1-3.

At block 720, the health care provider 150 identifies a medical record associated with the individual 101. In this example, the health care provider 150 identifies the medical record based on the user device's phone number; however in some examples, information may be contained within the received message, such as the individual's name, address, birth date, social security number, patient identification number, etc. The health care provider 150 may then access health care records, such as health care records 160, and identify one or more records associated with the individual 101. Means for performing the functionality described with respect to block 720 may include the example computing device 300 described above with respect to FIGS. 1-3

At block 730, the health care provider 150 updates the identified medical record. In this example, the health care provider 150 adds an entry to the identified medical record indicating the emergency condition, the date and time of the notification, and, if provided, such as by the ERS system 140, the name of a hospital or other health care provider that admitted the individual 101, a name of the attending doctor, or any other information obtained from the user device 110 or the ERS system 140. After the identified health record has been updated, the health care provider 150 may generate and transmit a message to a doctor or other health care worker indicating the identified health record, or by placing the identified and modified health care record within the doctor's work queue. Means for performing the functionality described with respect to block 730 may include the example computing device 300 described above with respect to FIGS. 1-3

It should be appreciated that the method 700 shown in FIG. 7 may be executed iteratively, such as if multiple messages having annotations are received over time.

While the methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

1. A method comprising:
transmitting, by a user device, an emergency call request to an emergency services provider;
prior to the emergency call request being answered or while the emergency call is interrupted or is put on hold:
recording, by the user device, audio signals comprising speech signals; and
obtaining one or more keywords from recognized words based on the speech signals; and
after detecting an emergency call connection or that the emergency call is resumed:
generating a message to the emergency services provider, the message comprising at least one of on the keywords; and
transmitting, by the user device, the message to the emergency services provider.

2. The method of claim 1, further comprising transmitting the recorded audio signals to the emergency services provider.

3. The method of claim 1, further comprising receiving, by the user device, a sensor signal from a sensor and, wherein the message comprises sensor information based on the sensor signal.

4. The method of claim 1, further comprising after detecting the emergency call connection:
receiving a second sensor signal from a second sensor;
continuing recording, by the user device, second audio signals comprising second speech signals;
obtaining one or more second keywords from recognized words based on the second speech signals; and
generating a second message to the emergency services provider based on the second keywords and the second sensor signal, the second message comprising a second annotation.

5. The method of claim 1, further comprising detecting, by the user device, an emergency condition prior to transmitting the emergency call request, and wherein the message comprises an indication of the emergency condition.

6. The method of claim 5, wherein detecting the emergency condition comprises:
(i) detecting an identified body part based on the speech signals
(ii) detecting an object name based on the speech signals;
(iii) detecting a drug name or drug type based on the speech signals; or
(iv) any combination of (i) to (iii).

7. The method of claim 1, outputting, by the user device, an audio prompt to indicate for a user to begin speaking.

8. The method of claim 1, further comprising:
for each emergency of a set of emergencies, determining a probability associated with the emergency based on the recognized words; and
selecting an emergency having the highest probability.

9. The method of claim 8, wherein the set of emergencies comprises (i) a fall, (ii) a heart attack, (iii) a stroke, (iv) a broken bone, or (v) any combination of (i) to (iv).

10. The method of claim 1, further comprising detecting slurred speech based on the speech signals.

11. The method of claim 1, wherein the user device comprises (i) a smartphone, (ii) a wearable device, (iii) a drug delivery device, (iv) a virtual personal assistant device, or (v) any combination of (i) to (iv).

12. The method of claim 1, further comprising obtaining medical information about a user of the user device.

13. The method of claim 12, wherein the medical information comprises (i) a chronic medical condition, (ii) a medical procedure, (iii) a drug prescription, (iv) participation in a clinical trial, (v) a drug dosage time, or (vi) any combination of (i) to (v).

14. The method of claim 1, further comprising transmitting, by the user device, the message to a health services provider.

15. The method of claim 14, wherein the health services provider comprises (i) a doctor, (ii) a caregiver, (iii) a hospital, (iv) an insurer, (v) a clinical research organization, (vi) a drug company, or (vii) any combination of (i) to (vi).

16. A device comprising:
a microphone;
a communications network interface;
a non-transitory computer-readable medium; and
a processor in communication with the microphone, the communications network interface, wherein the processor is configured to:
transmit, using the communications network interface, an emergency call request to an emergency services provider;
prior to the emergency call request being answered or while the emergency call is interrupted or is put on hold:
record audio signals obtained by the microphone, the audio signals comprising speech signals; and
obtain one or more keywords from recognized words based on the speech signals;
after detection of an emergency call connection or resumption of the emergency call:
generate a message to the emergency services provider, the message comprising at least one of the keywords; and
transmit the message to the emergency services provider.

17. The device of claim 16, wherein the processor is further configured to transmit the recorded audio signals to the emergency services provider.

18. The device of claim 16, further comprising a sensor, and wherein the processor is further configured to receive a sensor signal from a sensor and, wherein the message comprises sensor information based on the sensor signal.

19. The device of claim 16, wherein the processor is further configured to, after detection of the emergency call connection:
receive a second sensor signal from a second sensor;
continue recording second audio signals comprising second speech signals;
obtain one or more second keywords from recognized words based on the second speech signals; and
generate a second message to the emergency services provider based on the second keywords and the second sensor signal, the second message comprising a second annotation.

20. The device of claim 16, wherein the processor is further configured to detect an emergency condition prior to transmitting the emergency call request, and wherein the messages comprise an indication of the emergency condition.

21. The device of claim 20, wherein the processor is further configured to:
(i) detect an identified body part based on the speech signals
(ii) detect an object name based on the speech signals;
(iii) detect a drug name or drug type based on the speech signals; or
(iv) any combination of (i) to (iii).

22. The device of claim 16, wherein the processor is further configured to output an audio prompt to indicate for a user to begin speaking.

23. The device of claim 16, wherein the processor is further configured to:
for each emergency of a set of emergencies, determine a probability associated with the emergency based on the recognized words; and
select an emergency having the highest probability.

24. The device of claim 23, wherein the set of emergencies comprises (i) a fall, (ii) a heart attack, (iii) a stroke, (iv) a broken bone, or (v) any combination of (i) to (iv).

25. The device of claim 16, wherein the processor is further configured to detect slurred speech based on the speech signals.

26. The device of claim 16, wherein the device comprises (i) a smartphone, (ii) a wearable device, (iii) a drug delivery device, (iv) a virtual personal assistant device, or (v) any combination of (i) to (iv).

27. The device of claim 16, wherein the processor is further configured to obtain medical information about an individual associated with the speech signals.

28. The device of claim 27, wherein the medical information comprises (i) a chronic medical condition, (ii) a medical procedure, (iii) a drug prescription, (iv) participation in a clinical trial, (v) a drug dosage time, or (vi) any combination of (i) to (v).

29. The device of claim 16, wherein the processor is further configured to transmit the message to a health services provider.

30. The device of claim 29, wherein the health services provider comprises (i) a doctor, (ii) a caregiver, (iii) a hospital, (iv) an insurer, (v) a clinical research organization, (vi) a drug company, or (vii) any combination of (i) to (vi).

31. A non-transitory computer-readable medium comprising processor-executable instructions configured to cause a processor to:
transmit an emergency call request to an emergency services provider;
prior to the emergency call request being answered or while the emergency call is interrupted or is put on hold:
record audio signals, the audio signals comprising speech signals; and
obtain one or more keywords from recognized words based on the speech signals;
after detection of an emergency call connection or resumption of the emergency call:
generate a message to the emergency services provider, the message comprising at least one of the keywords; and
transmit the message to the emergency services provider.

32. An apparatus comprising:
means for transmitting an emergency call request to an emergency services provider;
means for recording audio signals prior to the emergency call request being answered or while the emergency call is interrupted or is put on hold, the audio signals comprising speech signals; and
means for obtaining one or more keywords from recognized words based on the speech signals;
means for generating a message to the emergency services provider after detection of an emergency call connection or resumption of the emergency call, the message comprising at least one of the keywords; and
means for transmitting the message to the emergency services provider.

33. A method comprising:
answering an emergency services call from a user device;
receiving a message from the user device, the message comprising at least one annotation associated with an emergency condition;
modifying an emergency response protocol for the emergency condition based on the annotation; and
initiating the modified emergency response protocol.

34. A method comprising:
receiving a message from a user device, the message comprising at least one annotation associated with an emergency condition, the user device associated with an individual;
identifying a medical record associated with the individual; and
updating the medical record based on the emergency condition.
